(19) United States
(12) Patent Application Publication
(10) Pub. No.: US 2024/0207830 A1
(43) Pub. Date: Jun. 27, 2024

(54) SCR CATALYST COMPRISING ZEOLITIC MATERIAL HAVING AFT FRAMEWORK STRUCTURE AND SYNTHESIS OF THE SAME

(71) Applicant: BASF Corporation, Florham Park, NJ (US)

(72) Inventors: Xiaoduo Qi, Shanghai (CN); Vivek Vattipalli, Iselin, NJ (US); Lihua Shi, Dalian (CN); Yu Dai, Shanghai (CN); Mingming Wei, Shanghai (CN); Haitao Liu, Dalian (CN); Jin Li, Dalian (CN)

(21) Appl. No.: 18/551,450

(22) PCT Filed: Mar. 22, 2022
(86) PCT No.: PCT/CN2022/082249

§ 371 Date: Sep. 20, 2023

(30) Foreign Application Priority Data
Mar. 23, 2021 (WO) PCT/CN2021/082413

(51) Int. Cl. B01J 29/76; B01D 53/94; B01J 35/57; B01J 37/00; B01J 37/03; C01B 39/48; F01N 3/20

(52) U.S. Cl. CPC B01J 29/76; B01D 53/9418; B01J 35/57; B01J 37/0018; B01J 37/03; C01B 39/48; F01N 3/2066; B01D 2255/20738; B01D 2255/20761; B01D 2255/50; B01D 2257/404; B01D 2258/01; C01P 2002/72; C01P 2004/03

(57) ABSTRACT

A SCR catalyst composition comprises an aluminosilicate zeolite having AFT framework structure and a promoter metal. Meanwhile, providing a process for preparing the aluminosilicate zeolite having AFT framework, and use of the zeolite for selective catalytic reduction of nitrogen oxides.

### FIELD OF THE INVENTION

The present invention relates to an SCR catalyst comprising a zeolitic material having AFT framework structure, a process for preparing the zeolitic material, and use of the zeolitic material for selective catalytic reduction of nitrogen oxides.

### BACKGROUND

Catalytic articles are essential for modern internal combustion engines to treat exhausts therefrom before emission to air. The exhausts from internal combustion engines typically comprise particulate matter (PM), nitrogen oxides (NOx) such as NO and/or NO₂, unburned hydrocarbons (HC), and carbon monoxide (CO). Control of emissions of nitrogen oxides (NOx) is always one of the most important topics in automotive field, due to the environmentally negative impact on ecosystem, animal and plant life.

One of effective techniques for removal of NOx from internal combustion engine exhausts, particularly diesel engine exhausts, is selective catalytic reduction (SCR) of NOx with ammonia or a secondary ammonia source. Small pore zeolites such as those having CHA, AEI or AFX framework structure have been found excellent as SCR catalysts for exhaust treatment. It will be desirable if the pool of SCR catalysts based on small pore zeolites could be expanded.

Zeolites having AFT framework structure were known as aluminophosphate (AIPO) small pore zeolites. Recently, aluminosilicate zeolite having AFT framework were also synthesized and reported, for example in U.S. Pat. No. 10,343,927 B2. The aluminosilicate zeolite having AFT framework, designated as SSZ-112 in U.S. Pat. No. 10,343,927 B2, was prepared from a synthesis gel comprising sources of SiO₂, Al₂O₃, Group 1 metal, hydroxide ions, hexamethonium dication ions as the first organic templates (Q1) and one or more of 1-methyl-1-alkylpyrrolidinium cations and 1-methyl-1-alkylpiperidinium cations as the second organic template (Q2), where each alkyl group is independently C₁-C₅ alkyl. It was mentioned that the zeolite SSZ-112 may be used as a catalyst for a wide variety of organic or inorganic conversion processes including alkylation, cracking, hydrocracking, isomerization, oligomerization, conversion of organic oxygenates (e.g., methanol and/or dimethyl ether) to olefins (e.g., ethylene, propylene), synthesis of monoalkylamines and dialkylamines, and the catalytic reduction of nitrogen oxides. However, the zeolite SSZ-12 was not tested for any catalysis performances in U.S. Pat. No. 10,343,927 B2.

It will also be desirable if a promising SCR catalyst based on a zeolite having AFT framework structure could be developed.

### SUMMARY OF THE INVENTION

It is an object of the present invention to provide an SCR catalyst based on a zeolite having AFT framework structure, which has desirable activity, particularly combined with excellent stability against aging at a high temperature, for example 800° C. or higher.

It has surprisingly been found that the object was achieved by an SCR catalyst composition which comprises an aluminosilicate zeolite having AFT framework structure and a promoter metal.

Another object of the present invention is to provide a novel process for preparing an aluminosilicate zeolite having AFT framework structure.

The object was achieved by using a combination of N,N,N, N′, N′, N′-hexaethyl alkylenediammonium organic structure directing agent and 1-methyl-1-alkylpiperidinium organic structure directing agent.

Accordingly, in one aspect, the present invention relates to an SCR catalyst composition which comprises an aluminosilicate zeolite having AFT framework structure and a promoter metal.

In another aspect, the present invention relates to a process for preparing an aluminosilicate zeolite having AFT framework structure, which includes
(1) providing a synthesis mixture comprising
   (A) a source for Al₂O₃,
   (B) a source for SiO₂,
   (C1) a source for first organic structure directing agent a N,N,N,N′,N′,N′-hexaethyl alkylenediammonium cation, and
   (C2) a source for second organic structure directing agent a 1-methyl-1-alkylpiperidinium cation wherein the piperidinium ring is optionally substituted at one or more of 2 to 6-positions, and
(2) subjecting the synthesis mixture to crystallization conditions to form an AFT zeolite.

In still another aspect, the present invention relates to use of the aluminosilicate zeolite having AFT framework structure obtained and/or obtainable by the process as described herein in catalysts for the selective catalytic reduction (SCR) of nitrogen oxides NOx.

In yet another aspect, the present invention relates to a catalytic article in form of extrudates comprising an SCR catalyst composition or in form of a monolith comprising a washcoat containing an SCR catalyst composition on a substrate, wherein the SCR catalyst composition comprises an aluminosilicate zeolite having AFT framework structure and a promoter metal.

In a further aspect, the present invention relates to an exhaust gas treatment system comprising an internal combustion engine and an exhaust gas conduit in fluid communication with the internal combustion engine, wherein the catalytic article as described herein is present in the exhaust gas conduit.

### BRIEF DESCRIPTION OF THE DRAWINGS

FIG. 1 shows SEM images of the zeolites from Examples 1 to 6 (Materials A to F) respectively.

FIG. 2 shows XRD patterns of the zeolites from Examples 1 to 6 (Materials A to F) respectively.

### DETAILED DESCRIPTION OF THE INVENTION

The present invention will be described in detail hereinafter. It is to be understood that the present invention may be embodied in many different ways and shall not be construed as limited to the embodiments set forth herein.

Herein, the singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

The term “AFT” as used herein refer to AFT framework type as recognized by the International Zeolite Association (IZA) Structure Commission.

The term “aluminosilicate” as used within the context of zeolite is intended to mean the framework constructed primarily of alumina and silica, which may or may not comprise a framework metal other than aluminum and silicon. When a framework metal other than aluminum is present in place of one or more aluminum or silicon framework atoms, the aluminosilicate zeolite may be referred to as “metal-substituted”.

The terms “zeolite having AFT framework structure”, “zeolite of AFT type”, “AFT zeolite” and the like as used herein are intended to refer to a material which shows an XRD pattern of an AFT framework structure, and will be used interchangeably with each other hereinbelow. Those terms are also intended to include any forms of the zeolite, for example as-synthesized form, calcined form, NH₄-exchanged form, H-form and metal-substituted form.

The term “as-synthesized” as used herein is intended to refer to a zeolite in its form after crystallization and drying, prior to removal of the organic structure directing agents.

The term “calcined form” as used herein is intended to refer to a zeolite in its form upon calcination.

The term “promoter metal” as used herein refers to a non-framework metal capable of improving the catalytic activity of a zeolite. The “non-framework metal” is intended to mean that the metal does not participate in constituting the zeolite framework structure. The promoter metal may reside within the zeolite and/or on at least a portion of the zeolite surface, preferably in form of ionic species.

Accordingly, the present invention provides an SCR catalyst composition comprising an aluminosilicate zeolite of AFT type and a promoter metal present within and/or on the aluminosilicate zeolite of AFT type.

The aluminosilicate zeolite of AFT type useful in the SCR catalyst composition according to the present invention is preferably at least 90% phase pure, i.e., at least 90% of the zeolite framework is of AFT type, as determined by X-ray powder diffraction (XRD) analysis. More preferably, the aluminosilicate zeolite of AFT type is at least 95% phase pure, or even more preferably at least 98% or at least about 99%.

In some embodiments, the aluminosilicate zeolite of AFT type may contain some other framework like AFX or CHA as intergrowth in minor amounts, for example less than 10%, preferably less than 5%, even more preferably less than 2% or less than 1%.

It is preferred that the aluminosilicate zeolite of AFT type has a molar ratio of silica to alumina (SAR) of 10 to 25, preferably 13 to 25, preferably 13 to 20, more preferably 13 to 18, as determined in its calcined H-form.

The aluminosilicate zeolite of AFT type useful in the SCR catalyst composition according to the present invention may have a mesopore surface area (MSA) of no more than 60 m²/g, preferably no more than 50 m²/g, more preferably no more than 45 m²/g, for example 1 to 50 m²/g, or 3 to 45 m²/g. Alternatively or additionally, the aluminosilicate zeolite of AFT type according to the present invention has a zeolitic surface area (ZSA) of at least 400 m²/g, or at least 450 m²/g, for example in the range of 450 to 650 m²/g, or 450 to 600 m²/g. The mesopore surface area and zeolitic surface area may be determined via N₂-adsorption porosimetry.

The aluminosilicate zeolite of AFT type typically has an average crystal size of up to 500 nm, particularly in the range of from 200 nm to 500 nm. The average crystal size may be determined via scanning electron microscopy (SEM). Particularly, the average crystal size was determined via SEM by measuring the crystal sizes for at least 30 different crystals selected at random from multiple images covering different areas of the sample.

The promoter metal may be any metals known useful for improving catalytic performance of zeolites in the application of selective catalytic reduction (SCR) of NOx. Generally, the promoter metal may be selected from transition metals, for example precious metals such as Au and Ag and platinum group metals, base metals such as Cr, Zr, Nb, Mo, Fe, Mn, W, V, Ti, Co, Ni, Cu and Zn, alkali earth metals such as Ca and Mg, and Sb, Sn and Bi, and any combinations thereof.

In a preferable embodiment, the SCR catalyst composition comprises at least Cu and/or Fe as the promoter metal. In some particular embodiments, the SCR catalyst composition comprises Cu as the promoter metal. Particularly, the promoter metal used in the SCR catalyst composition consists of Cu.

The promoter metal may be present in the SCR catalyst composition at an amount of 0.1 to 10% by weight, preferably 0.5 to 10% by weight, more preferably 1 to 7% by weight, particularly 2 to 5% by weight, on an oxide basis, based on the total weight of the promoter metal and the aluminosilicate zeolite of AFT type. In some particular embodiments wherein copper, iron or the combination thereof is used as the promoter metal, the promoter metal is preferably present in the SCR catalyst composition at an amount of 1 to 5% by weight, more preferably 2 to 4% by weight, on an oxide basis, based on the total weight of the promoter metal and the aluminosilicate zeolite of AFT type.

Alternatively, the promoter metal may be present in the SCR catalyst composition at an amount of 0.1 to 1.0 moles, preferably 0.2 to 0.7 moles, more preferably 0.3 to 0.5 moles, per mole of framework aluminum of the aluminosilicate zeolite of AFT type. In some particular embodiments wherein copper, iron or the combination thereof is used as the promoter metal, the amount of the promoter metal is 0.2 to 0.7 moles, preferably 0.3 to 0.5 moles per mole of framework aluminum of the aluminosilicate zeolite of AFT type.

In some preferable embodiments, the SCR catalyst composition comprises
an aluminosilicate zeolite of AFT type, which has a molar ratio of silica to alumina (SAR) of 13 to 25, preferably 13 to 20, and
a promoter metal present within and/or on the aluminosilicate zeolite, which is Cu and/or Fe, particularly Cu,
wherein the promoter metal is present at an amount of 0.2 to 0.7 moles, preferably 0.3 to 0.5 moles per mole of framework aluminum of the aluminosilicate zeolite.

In some more preferable embodiments, the SCR catalyst composition according to the present invention comprises
an aluminosilicate zeolite of AFT type, which has a molar ratio of silica to alumina (SAR) of 13 to 20, more preferably 13 to 18, and 40
a promoter metal Cu present within and/or on the aluminosilicate zeolite,
wherein Cu is present at an amount of 0.3 to 0.5 moles per mole of framework aluminum of the aluminosilicate zeolite.

In an exemplary embodiment, the SCR catalyst composition according to the present invention comprises
an aluminosilicate zeolite having AFT framework structure, which has a molar ratio of silica to alumina (SAR) of 13 to 18, and
a promoter metal Cu present within and/or on the aluminosilicate zeolite,
wherein Cu is present at an amount of 0.3 to 0.5 moles per mole of framework aluminum of the aluminosilicate zeolite.

The promoter metal may be incorporated into the aluminosilicate zeolite of AFT type via any known processes, for example ion exchange and impregnation. For example, the promoter metal may be incorporated into the aluminosilicate zeolite of AFT type by mixing the aluminosilicate zeolite into a solution of a soluble precursor of the promoter metal. The zeolite upon ion-exchanging with the promoter metal typically in form of cation may be conventionally washed, dried and calcined. Useful soluble precursors of the promoter metal may be for example salts of the promoter metal, complexes of the promoter metal or a combination thereof. Alternatively, the promoter metal may be incorporated into the aluminosilicate zeolite of AFT type in-situ during the preparation of catalytic articles such as extrudates or coated monolith.

It has been found that the SCR catalyst composition according to the present invention has a desirable activity in applications for selective catalytic reduction (SCR) of NOx. Moreover, it has been surprisingly found that the SCR catalyst composition according to the present invention also has an excellent stability against aging at a high temperature, for example 800° C. or higher, especially in the case that the aluminosilicate zeolite of AFT type is prepared using a particular combination of organic structure directing agents, i.e., the N,N, N, N′, N′, N′-hexaethyl alkylenediammonium cation and the 1-methyl-1-alkylpiperidinium cation wherein the piperidinium ring is optionally substituted at one or more of 2 to 6-positions.

Accordingly, in another aspect, the present invention further provides a process for preparing an aluminosilicate zeolite having AFT framework structure, which includes
(1) providing a synthesis mixture comprising
   (A) a source for Al₂O₃,
   (B) a source for SiO₂,
   (C1) a source for first organic structure directing agent comprising a N,N, N, N′, N′, N′-hexaethyl alkylenediammonium cation (OSDA1), and
   (C2) a source for second organic structure directing agent comprising a 1-methyl-1-alkylpiperidinium cation wherein the piperidinium ring is optionally substituted at one or more of 2 to 6-positions (OSDA2), and
(2) subjecting the synthesis mixture to crystallization conditions to form an AFT zeolite.

The first organic structure directing agent (OSDA1) particularly comprises a N, N, N, N′, N′, N′-hexaethyl alkylenediammonium cation wherein the alkylene moiety is selected from substituted or unsubstituted straight chain or branched C3-C10 alkanediyl, preferably unsubstituted straight chain or branched C3-C10 alkanediyl.

The first organic structure directing agent (OSDA1) preferably comprises a N, N, N, N′, N′, N′-hexaethyl alkylenediammonium cation represented by the following formula (I):

(C₂H₅)₃N⁺(CH₂)ₙN⁺(C₂H₅)₃ (I)

wherein
n is an integer of 3 to 10, preferably 4 to 7, most preferably 5.

In some embodiments, the first organic structure directing agent (OSDA1) comprises a cation selected from the group consisting of N,N,N,N′,N′, N′-hexaethyl-1,3-propanediammonium, N, N, N, N′, N′, N′-hexaethyl-1,4-butanediammonium, N, N, N, N′, N′, N′-hexaethyl-1,5-pentane-diammonium, N, N,N,N′, N′, N′-hexaethyl-1,6-hexanediammonium, N, N, N,N′, N′, N′-hexaethyl-1,7-heptanediammonium, and any combinations thereof. Preferably, the first organic structure directing agent comprises a cation selected from the group consisting of N,N,N, N′, N′, N′-hexaethyl-1,5-pentane-diammonium, N,N,N, N′, N′, N′-hexaethyl-1,6-hexanediammonium, N,N,N,N′,N′,N′-hexaethyl-1,7-heptanediammonium, and any combinations thereof, more preferably selected from N,N, N, N′, N′, N′-hexaethyl-1,5-pentane-diammonium.

The second organic structure directing agent (OSDA2) particularly comprises a 1-methyl-1-alkylpiperidinium cation represented by the following formula (II):

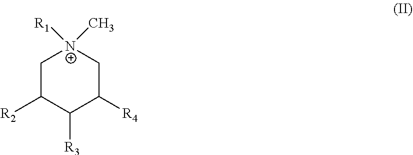

wherein
R₁ is C₁-C₅ alkyl, and
R₂, R₃ and R₄, independently from each other, are H, hydroxyl or C₁-C₅ alkyl;
or
R₁ and R₃ are linked together to form a 1 to 3-membered linkage between 1,4-positions, for example ethylene linkage, and
R₂ and R₄ independently from each other, are H, hydroxyl or C₁-C₅ alkyl.

The second organic structure directing agent (OSDA2) preferably comprises a 1-methyl-1-alkylpiperidinium cation represented by the formula (II) in which R₁ is C₁-C₅ alkyl, and R₂, R₃ and R₄, independently from each other, are H, hydroxyl or C₁-C₅ alkyl.

More preferably, the second organic structure directing agent (OSDA2) comprises a 1-methyl-1-alkylpiperidinium cation represented by the formula (II) in which R₁ is C₁-C5 alkyl, R₂ and R₄ independently from each other are H or C₁-C₅ alkyl, and R₃ is H.

In some embodiments, the second organic structure directing agent (OSDA2) comprises a cation selected from 1,1-dimethylpiperidinium, 1,1,3,5-tetramethylpiperidinium, 1-methyl-1-ethylpiperidinium, 1-methyl-1-propylpiperidinium, 1-methyl-1-butylpiperidinium, and any combinations thereof. Preferably, the second organic structure directing agent comprises a cation selected from the group consisting of 1-methyl-1-propylpiperidinium, 1-methyl-1-butylpiperidinium and any combinations thereof, more preferably selected from 1-methyl-1-propylpiperidinium.

In an exemplary embodiment of the process for preparing an aluminosilicate zeolite having AFT framework structure, the first organic structure directing agent (OSDA1) comprises N, N, N, N′, N′, N′-hexaethyl-1,5-pentane-diammonium cation and the second organic structure directing agent (OSDA2) comprises 1-methyl-1-propylpiperidinium cation.

The first and second organic structure directing agents may be used in a molar ratio in terms of diammonium cation to piperidinium cation in the range of 1:2 to 1:20, or 1:4 to 1:10, preferably 1:4 to 1:8, more preferably 1:5 to 1:7.

In a further exemplary embodiment of the process for preparing an aluminosilicate zeolite having AFT framework structure, the first organic structure directing agent comprises N, N,N, N′, N′, N′-hexaethyl-1,5-pentane-diammonium cation, the second organic structure directing agent comprises 1-methyl-1-propylpiperidinium cation, and the first and second organic structure directing agents are used in a molar ratio in terms of diammonium cation to piperidinium cation in the range of 1:4 to 1:8, preferably 1:5 to 1:7.

The synthesis mixture may or may not comprise a further organic structure directing agent. In some embodiments, the synthesis mixture does not comprise any organic structure directing agent other than the first and second organic structure directing agents.

Suitably, the first and second organic structure directing agents, independently from each other, are in form of halide such as fluoride, chloride and bromide, hydroxide, sulfate, nitrate and carboxylate such as acetate of respective quaternary ammonium cations, preferably chloride, bromide, hydroxide and sulfate.

Preferably, the first and second organic structure directing agents, independently from each other, are hydroxides of respective cations of formulae (I) and (II) as described herein above.

The first and second organic structure directing agents may be present in the synthesis mixture in a total molar ratio relative to source(s) for SiO₂, calculated as the sum of the quaternary ammonium cations (OSDA1+OSDA2) to SiO₂, in the range of from 0.01 to 1.0, preferably from 0.03 to 0.5, more preferably from 0.05 to 0.3.

There is no particular restriction to the sources for Al₂O₃ and SiO₂. Suitable examples of the source for Al₂O₃ may include, but are not limited to alumina, aluminates, aluminum alkoxides and aluminum salts, preferably alumina, aluminum tri(C₁-C₅) alkoxides, AIO(OH), AI(OH)₃, aluminum halide, aluminum sulfate, aluminum phosphate and aluminum fluorosilicate. Suitable examples of the source for SiO₂ may include, but are not limited to fumed silica, precipitated silica, silica hydrosols, silica gels, colloidal silica, silicic acid, silicon alkoxides, alkali metal silicates, sodium metasilicate hydrate, sesquisilicate, disilicate and silicic acid esters. Combined sources for Al₂O₃ and SiO₂ may be used alternatively or additionally, for example aluminosilicate zeolite such as FAU zeolite.

In some embodiments of the process for preparing an aluminosilicate zeolite having AFT framework structure, an FAU zeolite as the combined sources for Al₂O₃ and SiO₂ and an additional source for SiO₂ are used. Particularly the FAU zeolite is zeolite Y, preferably zeolite Y having a molar ratio of SiO₂ to Al₂O₃ of no more than 40, no more than 30, no more than 20, or even no more than 10. The additional source for SiO₂ is selected from the group consisting of fumed silica, precipitated silica, silica hydrosols, silica gels, colloidal silica.

The synthesis mixture provided in step (1) may comprise the source(s) for SiO₂ and the source(s) for Al₂O₃ in a molar ratio calculated as SiO₂ to Al₂O₃ in the range of from 5 to 100, preferably from 30 to 80, more preferably from 40 to 60.

The synthesis mixture provided in step (1) may further comprise a source for alkali metal and/or alkaline earth metal cations (AM), preferably alkali metal cations. The alkali metal is preferably selected from the group consisting of Li, Na, K, Cs and any combinations thereof, more preferably Na and/or K, and most preferably Na. The alkaline earth metal is preferably selected from the group consisting of Mg, Ca, Sr and Ba. Suitable sources for alkali metal and/or alkaline earth metal cations (AM) are typically halide such as fluoride, chloride and bromide, hydroxide, sulfate, nitrate and carboxylate such as acetate of alkali metal and/or alkaline earth metal, or any combinations thereof. Preferably, the sources for the alkali metal and/or alkaline earth metal cations (AM) include chloride, bromide, hydroxide or sulfate of the alkali metal and/or alkaline earth metal, or any combinations thereof. More preferably, hydroxide of alkali metal is used in the synthesis mixture.

The alkali metal and/or alkaline earth metal cations (AM) may be present in the synthesis mixture in a molar ratio relative to the source(s) for SiO₂, calculate as AM to SiO₂, in the range of from 0.01 to 1.0, preferably from 0.1 to 1.0, more preferably from 0.3 to 0.8.

The synthesis mixture provided in step (1) may also comprise a source for the anion OH—. Useful source for OH— may be for example a metal hydroxide such as alkali metal hydroxide or ammonium hydroxide. Preferably, the anion OH may be originated from one or more of the sources for alkali metal and/or alkaline earth metal cations (AM) and the sources for the first and/or second organic structure directing agents.

The OH anions may be present in the synthesis mixture in a molar ratio relative to the source(s) for SiO₂, calculated as OH— to SiO₂, in the range of from 0.1 to 2.0, more preferably from 0.2 to 1.0, more preferably from 0.5 to 1.0.

The synthesis mixture provided in step (1) may also comprise at least one solvent, preferably water, more preferably deionized water. The solvent may be comprised in one or more of starting materials of the synthesis mixture, such as the sources for Al₂O₃, SiO₂ and the first and/or second organic structure directing agents and thus be carried into the synthesis mixture, and/or may be incorporated into the synthesis mixture separately.

In some embodiments, the synthesis mixture has a molar ratio of water to the source(s) for SiO₂, calculated as H₂O to SiO₂, in the range of from 3 to 100, preferably from 10 to 80, more preferably from 20 to 60.

In some exemplary embodiments, the synthesis mixture provided in step (1) have a molar composition as shown in the Table 1 below:

TABLE 1

| Ingredient | General | Preferable | More Preferable |
|---|---|---|---|
| Ratios¹⁾ | (Broad) | (narrow) | (narrower) |
| SiO₂/Al₂O₃ | 5 to 100 | 30 to 80 | 40 to 60 |
| AM/SiO₂ | 0.01 to 1.0 | 0.1 to 1.0 | 0.3 to 0.8 |
| (OSDA1 + OSDA2)/SiO₂ | 0.01 to 1.0 | 0.03 to 0.5 | 0.05 to 0.3 |
| OH⁻/SiO₂ | 0.1 to 2.0 | 0.2 to 1.0 | 0.5 to 1.0 |
| H₂O/SiO₂ | 3 to 100 | 10 to 80 | 20 to 60 |

¹⁾the amounts of the sources for Al₂O₃ and SiO₂ are calculated as respective oxides, and the amounts of OSDA1 and OSDA2 are calculated as respective quaternary ammonium cations

In some embodiments, the synthesis mixture provided in step (1) may further comprise an amount of seed crystals of AFT zeolite. The seed crystals of AFT zeolite may be obtained from the process as described herein without using seed crystals.

The synthesis mixture may be subjected to crystallization conditions to form an AFT zeolite in step (2) with no particular restriction. The crystallization may be carried out at an elevated temperature in the range of from 80 to 250° C., more preferably from 100 to 200° C. for a period sufficient for crystallization, for example 0.5 to 12 days, 1 to 6 days, or 2 to 5 days. Typically, the crystallization is carried out under autogenous pressure, for example in a pressure tight vessel such as an autoclave. Further, the crystallization is preferably carried out without agitation.

The aluminosilicate zeolite as formed may be subjected to a work-up procedure including isolating for example by filtration, optionally washing, and drying to obtain the as-synthesized AFT zeolite. Accordingly, step (2) in the process according to the present invention optionally further comprises the work-up procedure.

The as-synthesized AFT zeolite typically comprises within its structure pores at least a portion of the first and second organic structure directing agents as described hereinabove.

In some embodiments, the as-synthesized AFT zeolite from step (2) may be subjected to a calcination procedure. Accordingly, the process according to the present invention further comprises step (3) of calcination of the as-synthesized AFT zeolite.

In some embodiments, the as-synthesized or the as-calcined AFT zeolite may be subjected to an ion-exchange procedure such that one or more of ionic non-framework elements contained in the zeolite are exchanged to H⁺ and/or NH₄⁺. Accordingly, the process according to the present invention further comprises
(4) exchanging one or more of ionic non-framework elements contained in the zeolite obtained in step (2) or (3) to H⁺ and/or NH₄⁺, preferably NH₄⁺.

Generally, the zeolite having been exchanged to H⁺ and/or NH₄⁺ in step (4) may be subjected to a work-up procedure including isolating for example by filtration, optionally washing, and drying, and/or subjected to a calcination procedure. Accordingly, step (4) in the process according to the present invention optionally further comprises the work-up procedure and/or calcination procedure.

The calcination in step (3) and/or step (4) may be carried out at a temperature in the range of from 300 to 900° C., for example 350 to 700° C., or 400 to 650° C. Particularly, the calcination may be performed in a gas atmosphere having a temperature in the above described ranges, which may be air, oxygen, nitrogen, or a mixture of two or more thereof. Preferably, the calcination is performed for a period in the range of from 0.5 to 10 hours, for example 3 to 7 hours, or 4 to 6 hours.

In some variants of the process for preparing an aluminosilicate zeolite having AFT framework structure according to the present invention, the second organic structure directing agent may not be used.

Accordingly, the present invention also provides a process for preparing an aluminosilicate zeolite having AFT framework structure, which includes
(1) providing a synthesis mixture comprising
   (A) a source for Al₂O₃,
   (B) a source for SiO₂,
   (C) a source for an organic structure directing agent comprising a N,N,N,N′,N′,N′-hexaethyl alkylenediammonium cation wherein the alkylene moiety (OSDA) is substituted or unsubstituted straight chain or branched chain, and
(2) subjecting the synthesis mixture to crystallization conditions to form an AFT zeolite.

In some particular embodiments, no organic structure directing agent other than the organic structure directing agent comprising a N,N,N,N′, N′, N′-hexaethyl alkylenediammonium cation as described hereinabove is used in the process according to the variants.

The N, N, N, N′, N′, N′-hexaethyl alkylenediammonium cations as described generally and preferably for any embodiments hereinabove are applicable here for the process according the variants.

In some particular embodiments according to the variants, the synthesis mixture provided in step (1) may have a molar composition as shown in the Table 2 below:

TABLE 2

| Ingredient | General | Preferable | More Preferable |
|---|---|---|---|
| Ratios¹⁾ | (Broad) | (narrow) | (narrower) |
| SiO₂/Al₂O₃ | 5 to 60 | 10 to 30 | 12 to 25 |
| AM/SiO₂ | 0.01 to 1.0 | 0.05 to 1.0 | 0.1 to 0.5 |
| OSDA/SiO₂ | 0.01 to 1.0 | 0.03 to 0.5 | 0.05 to 0.3 |
| OH⁻/SiO₂ | 0.1 to 2.0 | 0.1 to 1.0 | 0.2 to 0.6 |
| H₂O/SiO₂ | 3 to 100 | 10 to 80 | 20 to 60 |

¹⁾the amounts of the sources for Al₂O₃ and SiO₂ are calculated as respective oxides.

The process may be carried out otherwise in the same manner as described herein above for the process using the first and second organic structure directing agents.

Surprisingly, it has been found that the catalyst comprising the aluminosilicate zeolite having AFT framework structure obtained by the process as described herein exhibits significantly higher stability against aging at a temperature of 800° C. or higher, compared with the catalysts comprising a zeolite of the same framework type but prepared otherwise.

Accordingly, in still another aspect, the present invention provides use of the aluminosilicate zeolite having AFT framework structure obtained and/or obtainable by the process as described herein in catalysts for selective catalytic reduction (SCR) of nitrogen oxides NOx.

For the SCR applications, the aluminosilicate zeolite having AFT framework structure is preferably loaded with the promoter metal as described hereinabove, and applied in form of extrudates or in form of a washcoat on a monolithic substrate.

Accordingly, in yet another aspect, the present invention provides a catalytic article in form of catalyst composition extrudates or in form of a monolith comprising a washcoat containing a catalyst composition on substrate, wherein the catalyst composition comprises the aluminosilicate zeolite having AFT framework structure and the promoter metal as described hereinabove in each aspect.

The term “extrudates” generally refers to shaped bodies formed by extrusion. According to the present invention, the extrudates comprising the aluminosilicate zeolite having AFT framework structure and the promoter metal typically have a honeycomb structure.

The term “washcoat” has its usual meaning in the art, that is a thin, adherent coating of a catalytic or other material applied to a substrate.

The term “substrate” generally refers to a monolithic material onto which a catalytic coating is disposed, for example monolithic honeycomb substrate, particularly flow-through monolithic substrate and wall-flow monolithic substrate.

The aluminosilicate zeolite having AFT framework structure and the promoter metal may be processed into the application forms by any known processes with no particular restriction.

In a further aspect, the present invention relates to an exhaust gas treatment system comprising an internal combustion engine and an exhaust gas conduit in fluid communication with the internal combustion engine, wherein the catalytic article as described herein is present in the exhaust gas conduit.

### EMBODIMENTS

Various embodiments are listed below. It will be understood that the embodiments listed below may be combined with all aspects and other embodiments in accordance with the scope of the invention.

1. An SCR catalyst composition, which comprises an aluminosilicate zeolite having AFT framework structure and a promoter metal.

2. The SCR catalyst composition according to Embodiment 1, wherein the promoter metal is selected from transition metals, alkali earth metals, Sb, Sn and Bi, and any combinations thereof, preferably comprising Cu and/or Fe, preferably Cu.

3. The SCR catalyst composition according to Embodiment 2, wherein the promoter metal consists of Cu and/or Fe.

4. The SCR catalyst composition according to any of preceding Embodiments, wherein the promoter metal is within and/or on the aluminosilicate zeolite having AFT framework structure.

5. The SCR catalyst composition according to any of preceding Embodiments, wherein the aluminosilicate zeolite having AFT framework structure has a molar ratio of silica to alumina of 10 to 25, preferably 13 to 25, preferably 13 to 20, more preferably 13 to 18.

6. The SCR catalyst composition according to any of preceding Embodiments, wherein the aluminosilicate zeolite having AFT framework structure typically has an average crystal size of up to 500 nm, particularly in the range of from 200 nm to 500 nm.

7. The SCR catalyst composition according to any of preceding Embodiments, wherein the promoter metal is present at an amount of 0.1 to 1.0 moles, preferably 0.2 to 0.7 moles, more preferably 0.3 to 0.5 moles, per mole of framework aluminum of the aluminosilicate zeolite having AFT framework structure.

8. The SCR catalyst composition according to any of preceding Embodiments, wherein the aluminosilicate zeolite having AFT framework structure in its as-synthesized form comprises within its pores N, N,N, N′, N′, N′-hexaethyl alkylenediammonium cations and 1-methyl-1-alkylpiperidinium cations in which the piperidinium ring is optionally substituted at one or more of 2 to 6-positions.

9. The SCR catalyst composition according to any of preceding Embodiments 1 to 7, wherein the aluminosilicate zeolite having AFT framework structure in its as-synthesized form comprises within its pores only N, N, N, N′, N′, N′-hexaethyl alkylenediammonium cations as organic cations.

10. The SCR catalyst composition according to Embodiment 8 or 9, wherein the alkylene moiety in the N,N, N, N′, N′, N′-hexaethyl alkylenediammonium cation is selected from substituted or unsubstituted straight chain or branched C₃-C₁₀ alkanediyl, preferably unsubstituted straight chain or branched C₃-C₁₀ alkanediyl.

11. The SCR catalyst composition according to Embodiment 10, wherein the N, N, N, N′, N′, N′-hexaethyl alkylenediammonium cation is represented by the following formula (I):

(C₂H₅)₃N⁺(CH₂)ₙN⁺(C₂H₅)₃ (I)

wherein n is an integer of 3 to 10, preferably 4 to 7, most preferably 5.

12. The SCR catalyst composition according to any of Embodiments 8, 10 and 11, wherein the 1-methyl-1-alkylpiperidinium cation is represented by the following formula (II):

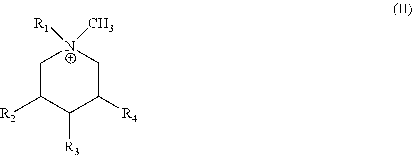

wherein
R₁ is C₁-C₅ alkyl, and
R₂, R₃ and R₄, independently from each other, are H, hydroxyl or C₁-C₅ alkyl; or
R₁ and R₃ are linked together to form a 1 to 3-membered linkage between 1,4-positions, for example ethylene linkage, and
R₂ and R₄ independently from each other, are H, hydroxyl or C₁-C₅ alkyl.

13. The SCR catalyst composition according to Embodiment 12, wherein the 1-methyl-1-alkylpiperidinium cation is represented by the formula (II) in which R₁ is C₁-C₅ alkyl, and R₂, R₃ and R₄, independently from each other, are H, hydroxyl or C₁-C₅ alkyl.

14. The SCR catalyst composition according to Embodiment 13, wherein the 1-methyl-1-alkylpiperidinium cation is represented by the formula (II) in which R₁ is C₁-C₅ alkyl, R₂ and R₄ independently from each other are H or C₁-C₈ alkyl, and R₃ is H.

15. The SCR catalyst composition according to Embodiment 14, wherein the aluminosilicate zeolite having AFT framework structure in its as-synthesized form comprises within its pores N,N, N, N′, N′, N′-hexaethyl-1,5-pentanediammonium cations and 1-methyl-1-propyl-piperidinium cations.

16. A process for preparing an aluminosilicate zeolite having AFT framework structure, which includes
(1) providing a synthesis mixture comprising
   (A) a source for Al₂O₃,
   (B) a source for SiO₂,
   (C1) a source for first organic structure directing agent comprising a N,N, N, N′, N′, N′-hexaethyl alkylenediammonium cation, and
   (C2) a source for second organic structure directing agent comprising a 1-methyl-1-alkylpiperidinium cation wherein the piperidinium ring is optionally substituted at one or more of 2 to 6-positions, and
(2) subjecting the synthesis mixture to crystallization conditions to form an AFT zeolite.

17. The process according to Embodiment 16, wherein the alkylene moiety in the N, N, N, N′, N′, N′-hexaethyl alkylenediammonium cation is selected from substituted or unsubstituted straight chain or branched C3-C10 alkanediyl, preferably unsubstituted straight chain or branched C3-C10 alkanediyl.

18. The process according to Embodiment 17, wherein the N, N,N, N′,N′, N′-hexaethyl alkylenediammonium cation is represented by the following formula (I):

(C₂H₅)₃N⁺(CH₂)ₙN⁺(C₂H₅)₃ (I)

wherein
n is an integer of 3 to 10, preferably 4 to 7, most preferably 5.

19. The process according to Embodiment 18, wherein the N, N, N, N′, N′, N′-hexaethyl alkylenediammonium cation is selected from the group consisting of N, N, N, N′, N′, N′-hexaethyl-1,3-propanediammonium, N, N, N, N′, N′, N′-hexaethyl-1,4-butanediammonium, N, N,N,N′, N′, N′-hexaethyl-1,5-pentanediammonium, N, N,N, N′, N′, N′-hexaethyl-1,6-hexanediammonium, N,N, N, N′, N′, N′-hexaethyl-1,7-heptanediammonium, and any combinations thereof, preferably from the group consisting of N, N, N, N′, N′, N′-hexaethyl-1,5-pentane-diammonium, N, N, N, N′,N′, N′-hexaethyl-1,6-hexanediammonium, N, N,N, N′, N′, N′-hexaethyl-1,7-heptanediammonium, and any combinations thereof, more preferably from N, N, N, N′, N′, N′-hexaethyl-1,5-pentane-diammonium.

20. The process according to any of Embodiments 16 to 19, wherein the 1-methyl-1-alkylpiperidinium cation is represented by the following formula (II):

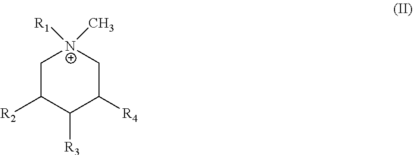

wherein
R₁ is C₁-C₅ alkyl, and
R₂, R₃ and R₄, independently from each other, are H, hydroxyl or C₁-C₅ alkyl; or
R₁ and R₃ are linked together to form a 1 to 3-membered linkage between 1,4-positions, for example ethylene linkage, and
R₂ and R₄ independently from each other, are H, hydroxyl or C₁-C₅ alkyl.

21. The process according to Embodiment 20, wherein the 1-methyl-1-alkylpiperidinium cation is represented by the formula (II) in which R₁ is C₁-C₅ alkyl, and R₂, R₃ and R₄, independently from each other, are H, hydroxyl or C₁-C₅ alkyl.

22. The process according to Embodiment 21, wherein the 1-methyl-1-alkylpiperidinium cation is represented by the formula (II) in which R₁ is C₁-C₅ alkyl, R₂ and R₄ independently from each other are H or C₁-C₈ alkyl, and R₃ is H.

23. The process according to Embodiment 22, wherein the 1-methyl-1-alkylpiperidinium cation is selected from 1,1-dimethylpiperidinium, 1,1,3,5-tetramethylpiperidinium, 1-methyl-1-ethylpiperidinium, 1-methyl-1-propylpiperidinium, 1-methyl-1-butylpiperidinium, and any combinations thereof, preferably from the group consisting of 1-methyl-1-propylpiperidinium, 1-methyl-1-butylpiperidinium and any combinations thereof, more preferably from 1-methyl-1-propylpiperidinium.

24. The process according to Embodiment 23, wherein the first organic structure directing agent comprises N,N,N, N′, N′, N′-hexaethyl-1,5-pentanediammonium cation and the second organic structure directing agent comprises 1-methyl-1-propylpiperidinium cation.

25. The process according to any of Embodiments 16 to 24, wherein the first and second organic structure directing agents are used in a molar ratio in terms of diammonium cation to piperidinium cation in the range of 1:2 to 1:20, or 1:4 to 1:10, preferably 1:4 to 1:8, more preferably 1:5 to 1:7.

26. The process according to any of Embodiments 16 to 25, wherein the sources for Al₂O₃ and SiO₂ comprise FAU zeolites, particularly zeolite Y, more preferably zeolite Y having a molar ratio of SiO₂ to Al₂O₃ of no more than 40, no more than 30, no more than 20, or even no more than 10.

27. The process according to Embodiment 26, wherein an additional source for SiO₂ is used.

28. Use of the aluminosilicate zeolite having AFT framework structure obtained or obtainable from the process according to any of Embodiments 16 to 27 in catalysts for selective catalytic reduction of nitrogen oxides.

29. A catalytic article, which is in form of catalyst composition extrudates or in form of a monolith comprising a washcoat containing a catalyst composition on substrate, wherein the catalyst composition is the SCR catalyst composition as defined in any of Embodiments 1 to 15, or wherein the catalyst composition comprises the aluminosilicate zeolite having AFT framework structure obtained or obtainable from the process according to any of Embodiments 16 to 27 and a metal promoter.

30. An exhaust gas treatment system, which comprises an internal combustion engine and an exhaust gas conduit in fluid communication with the internal combustion engine, wherein the catalytic article according to Embodiment 29 is present in the exhaust gas conduit.

31. A method for selective catalytic reduction of nitrogen oxides, including
(A) providing a gas stream comprising nitrogen oxides;
(B) contacting the gas stream with an SCR catalyst composition according to any of Embodiments 1 to 15 or the catalytic article according to Embodiment 29.

The invention will be further illustrated by following Examples, which set forth particularly advantageous embodiments. While the Examples are provided to illustrate the present invention, they are not intended to limit the present invention.

### EXAMPLES

In following Examples, scanning electron microscopy (SEM) measurements were performed by a scanning electron microscope (Hitachi SU1510).

X-ray powder diffraction (XRD) patterns were measured with PANalytical X′pert3 Powder Diffractometer (40 kV, 40 mA) using CuKa (λ=1.5406 Å) radiation to collect data in Bragg-Brentano geometry.

Example 1 Preparation of aluminosilicate AFT zeolite with hexamethonium hydroxide and 1-methyl-1-n-propylpiperidinium hydroxide as the organic structure directing agents (Material A, calcined H-form) 814.6 g of an aqueous solution of 1-methyl-1-n-propylpiperidinium hydroxide (12.6 wt %) and 80.2 g of an aqueous solution of hexamethonium hydroxide (25.3 wt %) were mixed with 2754.5 g of D.I. water, followed by addition of 110.8 g of sodium hydroxide (99%, solid). After sodium hydroxide dissolved, 44.9 g of Zeolite HY (SAR=7.2, from Shandong Duoyou) and 567.6 g of Ludox® AS-40 colloidal silica were added. After stirring at room temperature for 30 mins, the synthesis mixture was transferred into an autoclave for crystallization. The crystallization was carried out at 150° C. for 3 days under static condition. After cooling to room temperature, the zeolite product was collected by filtration and dried at 120° C. overnight. The as-synthesized zeolite was calcined at 550° C. for 6 hours to remove the organic structure directing agents.

The calcined zeolite was crushed and ion-exchanged in a 10 wt % aqueous NH₄Cl solution at a solid/liquid ratio of 1:10. The ion exchange was carried out at 80° C. for 2 hours and repeated twice. After ion exchange, the product was collected by filtration, washed with D.I. water, dried at 120° C. overnight, and calcined at 450° C. for 6 hours to obtain the calcined H-form zeolite.

The zeolite having a SiO₂/Al₂O₃ molar ratio of (SAR) of 12.7 as measured on the calcined H-form by XRF, and an MSA of 41 m²/g and ZSA of 524 m²/g as measured on the calcined H-form.

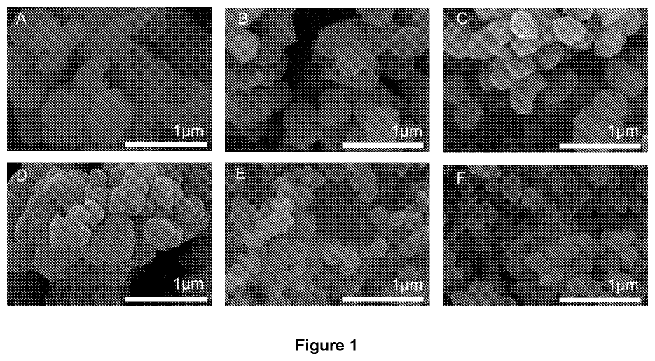

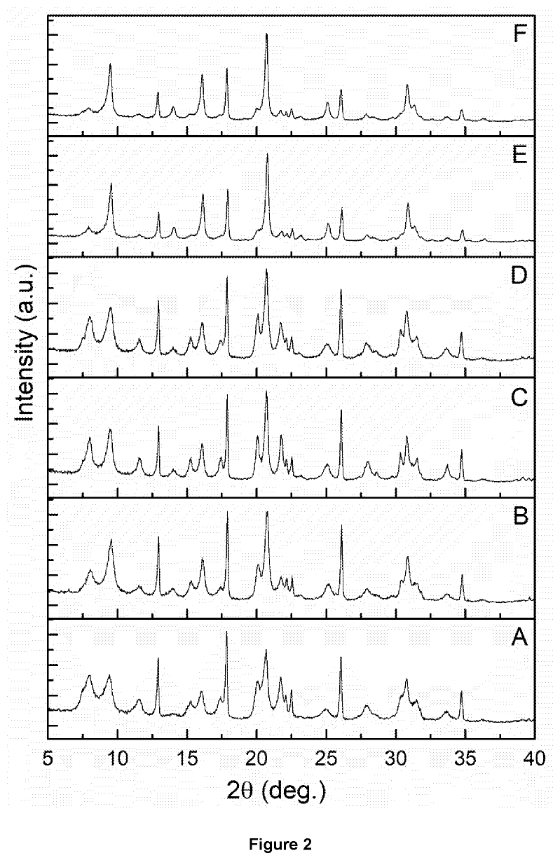

The crystal morphology of the zeolite observed from the SEM image and the XRD pattern of the zeolite are shown in FIG. 1 and FIG. 2 respectively. It was confirmed by the XRD pattern that the zeolite has a typical AFT framework.

Example 2 Preparation of aluminosilicate AFT zeolite with N, N, N,N′, N′, N′-hexaethyl-1,5-pentanediammonium hydroxide and 1-methyl-1-n-propylpiperidinium hydroxide as the organic structure directing agents (Material B, calcined H-form) 833.5 g of an aqueous solution of 1-methyl-1-n-propylpiperidinium hydroxide (12.6 wt %) and 182.8 g of an aqueous solution of N,N,N,N′, N′, N′-hexaethyl-1,5-pentanediammonium hydroxide (22.1 wt %) were mixed with 2163.6 g of D.I. water, followed by addition of 148.8 g of sodium hydroxide (99%, solid). After sodium hydroxide dissolved, 68.9 g of Zeolite HY (SAR=7.2, from Shandong Duoyou) and 871.2 g of Ludox® AS-40 colloidal silica were added. After stirring at room temperature for 30 mins, the synthesis mixture was transferred into an autoclave for crystallization. The crystallization was carried out at 150° C. for 3 days under static condition. After cooling to room temperature, the zeolite product was collected by filtration and dried at 120° C. overnight. The as-synthesized zeolite was calcined at 550° C. for 6 hours to remove the organic structure directing agents.

The calcined zeolite was crushed and ion-exchanged in a 10 wt % aqueous NH₄Cl solution at a solid/liquid ratio of 1:10. The ion exchange process was carried out at 80° C. for 2 hours and repeated twice. After ion exchange, the product was collected by filtration, washed with D.I. water, dried at 120° ° C. overnight, and calcined at 450° C. for 6 hours to obtain the calcined H-form zeolite.

The zeolite having a SiO₂/Al₂O₃ molar ratio of (SAR) of 16.7 as measured on the calcined H-form by XRF, a mesopore surface area (MSA) of 29 m²/g and a zeolitic surface area (ZSA) of 489 m²/g as measured on the calcined H-form.

The crystal morphology of the zeolite observed from the SEM image and the XRD pattern of the zeolite are shown in FIG. 1 and FIG. 2 respectively. It was confirmed by the XRD pattern that the zeolite has a typical AFT framework.

Example 3 Preparation of aluminosilicate AFT zeolite with N, N, N, N′, N′, N′-hexaethyl-1,5-pentanediammonium hydroxide and 1-methyl-1-n-propylpiperidinium hydroxide as the organic structure directing agents (Material C, calcined H-form) 833.5 g of an aqueous solution of 1-methyl-1-n-propylpiperidinium hydroxide (12.6 wt %) and 182.8 g of an aqueous solution of N,N, N,N′, N′, N′-hexaethyl-1,5-pentanediammonium hydroxide (22.1 wt %) were mixed with 2163.6 g of D.I. water, followed by addition of 170.1 g of sodium hydroxide (99%, solid). After sodium hydroxide dissolved, 68.9 g of Zeolite HY (SAR=7.2, from Shandong Duoyou) and 871.2 g of Ludox® AS-40 colloidal silica were added. After stirring at room temperature for 30 mins, the synthesis mixture was transferred into an autoclave for crystallization. The crystallization was carried out at 150° C. for 3 days under static condition. After cooling to room temperature, the zeolite product was collected by filtration and dried at 120° ° C. overnight. The as-synthesized zeolite was calcined at 550° C. for 6 hours to remove the organic structure directing agents.

The calcined zeolite was crushed and ion-exchanged in a 10 wt % aqueous NH₄Cl solution at a solid/liquid ratio of 1:10. The ion exchange process was carried out at 80° C. for 2 hours and repeated twice. After ion exchange, the product was collected by filtration, washed with D.I. water, dried at 120° C. overnight, and calcined at 450° C. for 6 hours to obtain the calcined H-form zeolite.

The zeolite having a SiO₂/Al₂O₃ molar ratio of (SAR) of 13.0 as measured on the calcined H-form by XRF, a mesopore surface area (MSA) of 44 m²/g and a zeolitic surface area (ZSA) of 503 m²/g as measured on the calcined H-form.

The crystal morphology of the zeolite observed from the SEM image and the XRD pattern of the zeolite are shown in FIG. 1 and FIG. 2 respectively. It was confirmed by the XRD pattern that the zeolite has a typical AFT framework.

Example 4 Preparation of aluminosilicate AFT zeolite with N, N, N, N′, N′, N′-hexaethyl-1,5-pentanediammonium hydroxide and 1-methyl-1-n-propylpiperidinium hydroxide as the organic structure directing agents (Material D, calcined H-form)

463.7 g of an aqueous solution of 1-methyl-1-n-propylpiperidinium hydroxide (12.6 wt %) and 94.2 g of an aqueous solution of N,N,N, N′, N′, N′-hexaethyl-1,5-pentanediammonium hydroxide (22.1 wt %) were mixed with 2679.5 g of D.I. water, followed by addition of 174.9 g of sodium hydroxide (99%, solid). After sodium hydroxide dissolved, 106.5 g of Zeolite HY (SAR=7.2, from Shandong Duoyou) and 836.4 g of Ludox® AS-40 colloidal silica were added. After stirring at room temperature for 30 mins, the synthesis mixture was transferred into an autoclave for crystallization. The crystallization was carried out at 150° C. for 3 days under static condition. After cooling to room temperature, the zeolite product was collected by filtration and dried at 120° C. overnight. The as-synthesized zeolite was calcined at 550° C. for 6 hours to remove the organic structure directing agents.

The calcined zeolite was crushed and ion-exchanged in a 10 wt % aqueous NH₄Cl solution at a solid/liquid ratio of 1:10. The ion exchange process was carried out at 80° C. for 2 hours and repeated twice. After ion exchange, the product was collected by filtration, washed with D.I. water, dried at 120° C. overnight, and calcined at 450° ° C. for 6 hours to obtain the calcined H-form zeolite.

The zeolite having a SiO₂/Al₂O₃ molar ratio of (SAR) of 13.2 as measured on the calcined H-form by XRF, a mesopore surface area (MSA) of 23 m²/g and a zeolitic surface area (ZSA) of 527 m²/g as measured on the calcined H-form.

The crystal morphology of the zeolite observed from the SEM image and the XRD pattern of the zeolite are shown in FIG. 1 and FIG. 2 respectively. It was confirmed by the XRD pattern that the zeolite has a typical AFT framework.

Example 5 Preparation of aluminosilicate AFT zeolite with N, N, N, N′, N′, N′-hexaethyl-1,5-pentanediammonium hydroxide as the organic structure directing agent (Material E, calcined H-form) 1038.7 g of an aqueous solution of N,N,N,N′, N′, N′-hexaethyl-1,5-pentanediammonium (22.1 wt %) were mixed with 1989.4 g of D.I. water, followed by addition of 52.38 g of sodium hydroxide (99%, solid). After sodium hydroxide dissolved, 260.95 g of HY (SAR=7.2, from Shandong Duoyou) and 675.0 g of Ludox® AS-40 colloidal silica were added. After stirring at room temperature for 30 mins, the synthesis mixture was transferred into an autoclave for crystallization. The crystallization was carried out at 180° C. for 2 days under static condition. After cooling to room temperature, the zeolite product was collected by filtration and dried at 120° C. overnight. The as-synthesized zeolite was calcined at 550° C. for 6 hours to remove the organic structure directing agents.

The calcined zeolite was crushed and ion-exchanged in a 10 wt % aqueous NH₄Cl solution at a solid/liquid ratio of 1:10. The ion exchange process was carried out at 80° C. for 2 hours and repeated twice. After ion exchange, the product was collected by filtration, washed with D.I. water, dried at 120° C. overnight, and calcined at 450° C. for 6 hours to obtain the H-form zeolite.

The zeolite having a SiO₂/Al₂O₃ molar ratio of (SAR) of 16.2 as measured on the calcined H-form by XRF, a mesopore surface area (MSA) of 42 m²/g and a zeolitic surface area (ZSA) of 539 m²/g as measured on the calcined H-form.

The crystal morphology of the zeolite observed from the SEM image and the XRD pattern of the zeolite are shown in FIG. 1 and FIG. 2 respectively. It was confirmed by the XRD pattern that the zeolite has a typical AFT framework.

Example 6 Preparation of aluminosilicate AFT zeolite with N, N,N, N′, N′, N′-hexaethyl-1,5-pentanediammonium hydroxide as the organic structure directing agent (Material F, calcined H-form)

1038.7 g of an aqueous solution of N, N, N,N′, N′, N′-hexaethyl-1,5-pentanediammonium (22.1 wt %) were mixed with 1989.4 g of D.I. water, followed by addition of 58.44 g of sodium hydroxide (99%, solid). After sodium hydroxide dissolved, 260.95 g of HY (SAR=7.2, from Shandong Duoyou) and 675.0 g of Ludox® AS-40 colloidal silica were added. After stirring at room temperature for 30 mins, the synthesis mixture was transferred into an autoclave for crystallization. The crystallization was carried out at 180ºC for 2 days under static condition. After cooling to room temperature, the zeolite product was collected by filtration and dried at 120° C. overnight. The as-synthesized zeolite was calcined at 550° C. for 6 hours to remove the organic structure directing agents.

The calcined zeolite was crushed and ion-exchanged in a 10 wt % aqueous NH₄Cl solution at a solid/liquid ratio of 1:10. The ion exchange process was carried out at 80° ° C. for 2 hours and repeated twice. After ion exchange, the product was collected by filtration, washed with D.I. water, dried at 120° ° C. overnight, and calcined at 450° C. for 6 hours to obtain the H-form zeolite.

The zeolite having a SiO₂/Al₂O₃ molar ratio of (SAR) of 15.6 as measured on the calcined H-form by XRF, a mesopore surface area (MSA) of 43 m²/g and a zeolitic surface area (ZSA) of 546 m²/g as measured on the calcined H-form.

The crystal morphology of the zeolite observed from the SEM image and the XRD pattern of the zeolite are shown in FIG. 1 and FIG. 2 respectively. It was confirmed by the XRD pattern that the zeolite has a typical AFT framework.

### Example 7 Preparation of Cu— or Fe—Loaded AFT Zeolite Material (SCR Catalyst)

The H-form zeolite powder as obtained was impregnated with an aqueous copper (II) nitrate solution or an aqueous iron(III) nitrate solution by incipient wetness impregnation and maintained at 50° C. for 20 hours in a sealed container. The obtained solid was dried and calcined in air in a furnace at 450° ° C. for 5 hours, to obtain a Cu— or Fe-loaded zeolite.

The Cu-loaded AFT zeolite materials and Fe-loaded AFT zeolite materials as prepared in accordance with the above general procedure are summarized in the Table 3 below.

TABLE 3

| | | Promoter | Loading Amount, wt % | M/Al |
|---|---|---|---|---|
| No. | Zeolite | Metal (M) | on oxide basis, | Molar Ratio |
| 1.1 | Example 1 | Cu | 5.6 | 0.32 |
| 1.2 | Example 1 | Cu | 6.3 | 0.36 |
| 1.3 | Example 1 | Cu | 6.9 | 0.4 |
| 1.4 | Example 1 | Cu | 7.6 | 0.44 |
| 2.1 | Example 2 | Cu | 4.4 | 0.32 |
| 2.2 | Example 2 | Cu | 5 | 0.36 |
| 2.3 | Example 2 | Cu | 5.5 | 0.4 |
| 2.4 | Example 2 | Cu | 6 | 0.44 |
| 3.1 | Example 3 | Cu | 5.4 | 0.32 |
| 3.2 | Example 3 | Cu | 6.1 | 0.36 |
| 3.3 | Example 3 | Cu | 6.8 | 0.4 |
| 4.1 | Example 4 | Cu | 5.5 | 0.32 |
| 4.2 | Example 4 | Cu | 6.1 | 0.36 |
| 4.3 | Example 4 | Cu | 6.7 | 0.4 |
| 5.1 | Example 3 | Fe | 4.3 | 0.25 |
| 5.2 | Example 3 | Fe | 6.8 | 0.4 |

### Example 8 Test of Catalyst Performance

For test of SCR performance, the Cu— or Fe-loaded zeolite materials were slurried with an aqueous solution of Zr-acetate and then dried at ambient temperature in air under stirring, and calcined at 550° ° C. for 1 hour to provide a product containing 5 wt % ZrO₂ as the binder based on the amount of the product. The product was crushed and the powder fraction of 250 to 500 microns was used as samples for the test. A portion of the obtained powder was aged at 650° ° C. for 50 hours or 820° C. for 16 hours in a flow of 10 vol % steam/air to provide aged samples.

The selective catalytic reduction (SCR) test was carried out in a fixed-bed reactor with loading of 120 mg of the test sample together with corundum of the same sieve fraction as diluent to about 1 mL bed volume, in accordance with following conditions:
Gas feed: 500 vppm NO, 500 vppm NH₃, 5 vol % H₂O, 10 vol % O₂ and balance of N₂, with gas hourly space velocity (GHSV) of 80,000 h⁻¹ or 120,000 h⁻¹;
Temperature: RUN1-200, 400, 575° C.(first run for degreening) RUN2-175, 200, 225, 250, 350, 450, 550, 575° C.

NOx conversions as measured from RUN 2 at 200° C. and 575° C. are reported as the test results.

Results of the test samples in fresh state, aged at 650° C. and aged at 820° C. are summarized in Tables 4, 5 and 6 below, respectively.

TABLE 4
Results of Cu-loaded samples in fresh state

| Sample | GHSV, | NOx conversion @ | NOx conversion @ |
|---|---|---|---|
| No. | h⁻¹ | 200° C., % | 575° C., % |
| 1.1 | 80000 | 72 | 99 |
| 1.2 | 80000 | 82 | 98 |
| 1.3 | 80000 | 82 | 98 |
| 1.4 | 80000 | 83 | 91 |
| 2.1 | 80000 | 83 | 96 |
| 2.2 | 80000 | 85 | 94 |
| 2.3 | 80000 | 86 | 89 |
| 2.4 | 80000 | 82 | 85 |
| 3.1 | 120000 | 73 | 97 |
| 3.2 | 120000 | 76 | 90 |
| 3.3 | 120000 | 80 | 83 |
| 4.1 | 120000 | 71 | 98 |
| 4.2 | 120000 | 73 | 94 |
| 4.3 | 120000 | 73 | 92 |

TABLE 5
Results of Cu-loaded samples aged @650° C.

| Sample | GHSV, | NOx conversion @ | NOx conversion @ |
|---|---|---|---|
| No. | h⁻¹ | 200° C., % | 575° C., % |
| 1.1 | 80,000 | 74 | 97 |
| 1.2 | 80,000 | 82 | 93 |
| 1.3 | 80,000 | 85 | 91 |
| 1.4 | 80,000 | 80 | 94 |
| 2.1 | 80,000 | 76 | 93 |
| 2.2 | 80,000 | 82 | 90 |
| 2.3 | 80,000 | 84 | 87 |
| 2.4 | 80,000 | 84 | 82 |
| 3.1 | 120,000 | 74 | 94 |
| 3.2 | 120,000 | 79 | 86 |
| 3.3 | 120,000 | 66 | 72 |
| 4.1 | 120,000 | 67 | 95 |
| 4.2 | 120,000 | 73 | 94 |
| 4.3 | 120,000 | 72 | 89 |

TABLE 6
Results of Cu-loaded samples aged @820° C.

| Sample | GHSV, | NOx conversion @ | NOx conversion @ |
|---|---|---|---|
| No. | h⁻¹ | 200° C., % | 575° C., % |
| 1.1 | 80,000 | 0 | 0 |
| 1.2 | 80,000 | 0 | 10 |
| 1.3 | 80,000 | 0 | 8 |
| 1.4 | 80,000 | 0 | 3 |
| 2.1 | 80,000 | 54 | 86 |
| 2.2 | 80,000 | 59 | 84 |
| 2.3 | 80,000 | 67 | 73 |
| 2.4 | 80,000 | 59 | 55 |
| 3.1 | 120,000 | n.a.¹ | n.a.¹ |
| 3.2 | 120,000 | 56 | 89 |
| 3.3 | 120,000 | 63 | 88 |
| 4.1 | 120,000 | 77 | 91 |
| 4.2 | 120,000 | 79 | 84 |
| 4.3 | 120,000 | 64 | 73 |

¹The sample was not tested.

It can be seen that the catalysts comprising Cu-loaded AFT zeolite are effective for selective catalytic reduction (SCR) of nitrogen oxides, after aging at a high temperature of 650° C.

Surprisingly, upon aging at 820° C., the catalysts comprising Cu-loaded AFT zeolite wherein the AFT zeolite was prepared using the combination of N,N,N,N′,N′,N′-hexaethyl-1,5-pentanediammonium and 1-methyl-1-propylpiperidinium cations show greatly improved NOx conversions compared with the catalysts having the same Cu/Al ratio but with the AFT zeolite being prepared using hexamethonium and 1-methyl-1-propylpiperidinium cations. The catalysts comprising Cu-loaded AFT zeolite wherein the AFT zeolite was prepared using the combination of N,N,N,N′, N′, N′-hexaethyl-1,5-pentanediammonium and 1-methyl-1-propylpiperidinium cations upon aging at 820° C. resulted in NOx conversions @ 200° C. of at least 54%, even up to 79%, and resulted in NOx conversions @ 575° C. of at least 55%, even up to 91%, while the NOx conversions in case of corresponding catalysts with the AFT zeolite being prepared using hexamethonium and 1-methyl-1-propylpiperidinium cations are no more than 10%, or even “0”. The comparatively high SCR activity of the catalysts after aging at 820° C. reflects high stability of the AFT zeolite at an extremely high temperature.

The test samples of the catalysts comprising Fe-loaded AFT zeolite were also tested in accordance with the methods as described hereinabove under following conditions:
Gas feed: 500 vppm NO, 500 vppm NH₃, 5 vol % H₂O, 10 vol % O₂ and balance of (standard SCR) N₂, with gas hourly space velocity (GHSV) of 80,000 h 1;
Gas feed: 50 vppm NO, 250 vppm NO₂, 500 vppm NH₃, 5 vol % H₂O, 10 vol % O₂ (fast SCR) and balance of N₂, with gas hourly space velocity (GHSV) of 80,000 h⁻¹
Temperature: RUN1-200, 400, 575° C.(first run for degreening) RUN2-175, 200, 225, 250, 350, 450, 550, 575° C.

The results are summarized in Table 7 below.

TABLE 7
Results of Fe-loaded samples

| | | | | | | | |
|---|---|---|---|---|---|---|---|
| Sample No. | 200° C. | 225° C. | 250° C. | 350° C. | 450° C. | 550° C. | 575° C. |

Standard SCR

| | | | | | | | | |
|---|---|---|---|---|---|---|---|---|
| 5.1 | Fresh | 3.4 | 5.7 | 10.7 | 55.8 | 89.7 | 98.6 | 98.1 |
| | 650° C. aged | 5.7 | 10.6 | 18.2 | 60.7 | 80.3 | 88.5 | 90.4 |
| | 820° C. aged | 2.5 | 3.2 | 4.3 | 13.8 | 38.7 | 62.3 | 64.5 |
| 5.2 | Fresh | 3.5 | 6.4 | 12.3 | 62.0 | 94.0 | 99.2 | 99.1 |
| | 650° C. aged | 6.1 | 11.8 | 20.4 | 64.3 | 82.7 | 90.2 | 91.7 |
| | 820° C. aged | 2.3 | 3.0 | 4.1 | 13.6 | 39.3 | 63.5 | 66.1 |

Fast SCR

| | | | | | | | | |
|---|---|---|---|---|---|---|---|---|
| 5.1 | Fresh | 44.6 | 71.8 | 83.7 | 93.2 | 99.3 | 93.5 | 90.8 |
| | 650° C. aged | 22.7 | 48.1 | 80.8 | 94.2 | 99.6 | 93.8 | 91.1 |
| | 820° C. aged | 19.5 | 30.4 | 47.2 | 90.5 | 95.7 | 89.8 | 87.3 |
| 5.2 | Fresh | 41.8 | 71.1 | 86.7 | 94.0 | 99.4 | 96.0 | 94.1 |
| | 650° C. aged | 22.3 | 48.6 | 82.3 | 95.3 | 99.7 | 94.5 | 92.0 |
| | 820° C. aged | 19.3 | 30.1 | 48.0 | 89.8 | 95.5 | 91.3 | 89.8 |

It can be seen that the catalysts comprising Fe-loaded AFT zeolite are also effective for selective catalytic reduction of NOx after aging at high temperature.

1. An SCR catalyst composition, which comprises an aluminosilicate zeolite having AFT framework structure and a promoter metal.

2. The SCR catalyst composition according to claim 1, wherein the promoter metal is selected from transition metals, alkali earth metals, Sb, Sn and Bi, and any combinations thereof.

3. The SCR catalyst composition according to claim 2, wherein the promoter metal consists of Cu and/or Fe.

4. The SCR catalyst composition according to claim 1, wherein the promoter metal is within and/or on the aluminosilicate zeolite having AFT framework structure.

5. The SCR catalyst composition according to claim 1, wherein the aluminosilicate zeolite having AFT framework structure has a molar ratio of silica to alumina of 10 to 25, preferably 13 to 25.

6. The SCR catalyst composition according to claim 1, wherein the aluminosilicate zeolite having AFT framework structure typically has an average crystal size of up to 500 nm.

7. The SCR catalyst composition according to claim 1, wherein the promoter metal is present at an amount of 0.1 to 1.0 moles; more preferably 0.3 to 0.5 moles, per mole of framework aluminum of the aluminosilicate zeolite having AFT framework structure.

8. The SCR catalyst composition according to claim 1, preceding claims, wherein the aluminosilicate zeolite having AFT framework structure in its as-synthesized form comprises within its pores N,N,N,N′,N′,N′-hexaethyl alkylenediammonium cations and 1-methyl-1-alkylpiperidinium cations in which the piperidinium ring is optionally substituted at one or more of 2 to 6-positions.

9. The SCR catalyst composition according to claim 1, wherein the aluminosilicate zeolite having AFT framework structure in its as-synthesized form comprises within its pores only N,N,N,N′, N′,N′-hexaethyl alkylenediammonium cations as organic cations.

10. The SCR catalyst composition according to claim 8, wherein the alkylene moiety in the N,N, N,N′, N′, N′-hexaethyl alkylenediammonium cation is selected from substituted or unsubstituted straight chain or branched C3-C10 alkanediyl.

11. The SCR catalyst composition according to claim 10, wherein the N,N,N,N′,N′,N′-hexaethyl alkylenediammonium cation is represented by the following formula (I):
(C₂H₅)₃N⁺(CH₂)ₙN⁺(C₂H₅)₃ (I)
wherein
n is an integer of 3 to 10.

12. The SCR catalyst composition according to claim 8, wherein the 1-methyl-1-alkylpiperidinium cation is represented by the following formula (II): 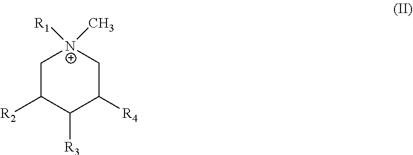
wherein
R₁ is C₁-C₅ alkyl, and
R₂, R₃ and R₄, independently from each other, are H, hydroxyl or C₁-C₈ alkyl;
or
R₁ and R₃ are linked together to form a 1 to 3-membered linkage between 1,4-positions, for example ethylene linkage, and
R₂ and R₄ independently from each other, are H, hydroxyl or C₁-C₅ alkyl.

13. The SCR catalyst composition according to claim 12, wherein the 1-methyl-1-alkylpiperidinium cation is represented by the formula (II) in which R₁ is C₁-C₈ alkyl, and R₂, R₃ and R₄, independently from each other, are H, hydroxyl or C₁-C₅ alkyl.

14. (canceled)

15. The SCR catalyst composition according to claim 3, wherein the aluminosilicate zeolite having AFT framework structure in its as-synthesized form comprises within its pores N,N,N,N′,N′,N′-hexaethyl-1,5-pentanediammonium cations and 1-methyl-1-propyl-piperidinium cations.

16. A process for preparing an aluminosilicate zeolite having AFT framework structure, which includes
(1) providing a synthesis mixture comprising
(A) a source for Al₂O₃,
(B) a source for SiO₂,
(C1) a source for first organic structure directing agent comprising a N,N,N,N′,N′,N′-hexaethyl alkylenediammonium cation, and
(C2) a source for second organic structure directing agent comprising a 1-methyl-1-alkylpiperidinium cation wherein the piperidinium ring is optionally substituted at one or more of 2 to 6-positions, and
(2) subjecting the synthesis mixture to crystallization conditions to form an AFT zeolite.

17. The process according to claim 16, wherein the alkylene moiety in the N,N,N,N′, N′, N′-hexaethyl alkylenediammonium cation is selected from substituted or unsubstituted straight chain or branched C3-C10 alkanediyl.

18. (canceled)

19. The process according to claim 17, wherein the N, N,N,N′, N′,N′-hexaethyl alkylenediammonium cation is selected from the group consisting of N,N,N,N′,N′,N′-hexaethyl-1,3-propanediammonium, N,N,N,N′,N′,N′-hexaethyl-1,4-butanediammonium, N,N,N,N′,N′,N′-hexaethyl-1,5-pentanediammonium, N,N,N,N′,N′,N′-hexaethyl-1,6-hexanediammonium, N,N,N,N′,N′,N′-hexaethyl-1,7-heptanediammonium, and any combinations thereof.

20. The process according to claim 16, wherein the 1-methyl-1-alkylpiperidinium cation is represented by the following formula (II): 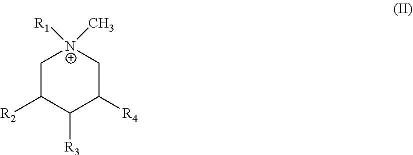
wherein
R₁ is C₁-C₅ alkyl, and
R₂, R₃ and R₄, independently from each other, are H, hydroxyl or C₁-C₅ alkyl;
or
R₁ and R₃ are linked together to form a 1 to 3-membered linkage between 1,4-positions, for example ethylene linkage, and
R₂ and R₄ independently from each other, are H, hydroxyl or C₁-C₅ alkyl.

21. The process according to claim 20, wherein the 1-methyl-1-alkylpiperidinium cation is represented by the formula (II) in which R₁ is C₁-C₅ alkyl, and R₂, R₃ and R₄, independently from each other, are H, hydroxyl or C1-C5 alkyl.

22. (canceled)

23. The process according to claim 20, wherein the 1-methyl-1-alkylpiperidinium cation is selected from 1,1-dimethylpiperidinium, 1,1,3,5-tetramethylpiperidinium, 1-methyl-1-ethylpiperidinium, 1-methyl-1-propylpiperidinium, 1-methyl-1-butylpiperidinium, and any combinations thereof.

24. The process according to claim 23, wherein the first organic structure directing agent comprises N,N,N,N′,N′,N′-hexaethyl-1,5-pentanediammonium cation and the second organic structure directing agent comprises 1-methyl-1-propylpiperidinium cation.

25. The process according to claim 16, wherein the first and second organic structure directing agents are used in a molar ratio in terms of diammonium cation to piperidinium cation in the range of 1: 2 to 1: 20, or 1: 4 to 1: 10.

26. The process according to claim 16, wherein the sources for Al₂O₃ and SiO₂ comprise FAU zeolites, particularly zeolite Y having a molar ratio of SiO₂ to Al₂O₃ of no more than 40, no more than 30, no more than 20, or even no more than 10.

27. (canceled)

28. (canceled)

29. A catalytic article, which is in form of extrudates comprising a catalyst composition or in form of a monolith comprising a washcoat containing a catalyst composition on substrate, wherein the catalyst composition is the SCR catalyst composition as defined in claim 1.

30. An exhaust gas treatment system, which comprises an internal combustion engine and an exhaust gas conduit in fluid communication with the internal combustion engine, wherein the catalytic article according to claim 29 is present in the exhaust gas conduit.

31. A method for selective catalytic reduction of nitrogen oxides, including
(A) providing a gas stream comprising nitrogen oxides;
(B) contacting the gas stream with an SCR catalyst composition according to claim 1.
